(19) United States
(12) Patent Application Publication
(10) Pub. No.: US 2026/0279099 A1
(43) Pub. Date: Sep. 17, 2026

(54) IMAGE GENERATION METHOD AND APPARATUS, ELECTRONIC DEVICE, AND STORAGE MEDIUM

(71) Applicant: Tencent Technology (Shenzhen) Company Limited, Shenzhen (CN)

(72) Inventor: Lei SHEN, Shenzhen (CN)

(73) Assignee: Tencent Technology (Shenzhen) Company Limited, Shenzhen (CN)

(21) Appl. No.: 19/667,971

(22) Filed: May 5, 2026

Related U.S. Application Data
(63) Continuation of application No. PCT/CN2024/115106, filed on Aug. 28, 2024.

(30) Foreign Application Priority Data
Nov. 8, 2023 (CN) 202311475037.5

(51) Int. Cl. G06V 40/16; G06V 10/77; G06V 10/80; G06V 10/82

(52) U.S. Cl. CPC G06V 40/172; G06V 10/7715; G06V 10/806; G06V 10/82; G06V 40/166; G06V 40/169

(57) ABSTRACT

An image generation method, performed by a computer device, includes: obtaining a real biometric image of a target object (201); performing, on the real biometric image, a plurality of image transformations with an identity feature of the target object retained, to obtain transformed images respectively corresponding to the plurality of image transformations (202); performing feature extraction on the transformed images respectively corresponding to the plurality of image transformations, to obtain image features of the transformed images (203); generating, based on the image features of the transformed images, a general feature of the target object (204); separately extracting, from the image features of the transformed images, an image transformation feature irrelevant to the identity feature of the target object (205); fusing the general feature with the image transformation feature, to obtain a fused feature (206); and generating, based on the fused feature, a simulated biometric image of the target object (207).

### RELATED APPLICATION

This application is a continuation of International Patent Application No. PCT/CN2024/115106, filed on Aug. 28, 2024, which claims priority to Chinese Patent Application No. 202311475037.5, filed on Nov. 8, 2023, entitled “IMAGE GENERATION METHOD AND APPARATUS, ELECTRONIC DEVICE, AND STORAGE MEDIUM”. Both of the applications are incorporated herein by reference in their entirety.

### FIELD OF THE TECHNOLOGY

This application relates to the field of image processing, and specifically, to an image generation method and apparatus, an electronic device, and a storage medium.

### BACKGROUND OF THE DISCLOSURE

Small-sample image generation refers to training an image generator to predict a new image with a small number of learning samples. However, with an excessively small number of learning samples, for example, there are only one or two picture samples, the image generator suffers from a very serious overfitting problem. A common solution is to use a generative adversarial network (GAN), a variational autoencoder (VAE), and the like to address the overfitting problem with the excessively small number of learning samples and generate the new image. However, due to complexity of these methods, a large amount of generation time and a large number of computing resources are usually needed.

Therefore, a current method for generating an image with an excessively small number of learning samples are inefficient.

### SUMMARY

Embodiments of this application provide an image generation method and apparatus, an electronic device, and a storage medium.

According to a first aspect, an embodiment of this application provides an image generation method, performed by a computer device, and including:
obtaining a real biometric image of a target object;
performing, on the real biometric image, a plurality of image transformations with an identity feature of the target object retained, to obtain transformed images respectively corresponding to the plurality of image transformations;
performing feature extraction on the transformed images respectively corresponding to the plurality of image transformations, to obtain image features of the transformed images;
generating, based on the image features of the transformed images, a general feature of the target object;
fusing the general feature with the image transformation feature, to obtain a fused feature; and
generating, based on the fused feature, a simulated biometric image of the target object.

According to a second aspect, an embodiment of this application further provides an image generation apparatus, including:
an obtaining unit, configured to obtain a real biometric image of a target object;
a transformation unit, configured to perform, on the real biometric image, a
plurality of image transformations with an identity feature of the target object retained, to obtain transformed images respectively corresponding to the plurality of image transformations;
an image feature extraction unit, configured to perform feature extraction on the transformed images respectively corresponding to the plurality of image transformations, to obtain image features of the transformed images;
a general feature generation unit, configured to generate, based on the image features of the transformed images, a general feature of the target object;
a fusion unit, configured to fuse the general feature with the image transformation feature, to obtain a fused feature; and
a simulated image generation unit, configured to generate, based on the fused feature, a simulated biometric image of the target object.

According to a third aspect, an embodiment of this application further provides an electronic device, including a memory having a plurality of instructions stored therein, and a processor loading instructions from the memory, to perform the operations in any image generation method provided in the embodiments of this application.

According to a fourth aspect, an embodiment of this application further provides a computer-readable storage medium, the computer-readable storage medium having a plurality of instructions stored therein, and the instructions being suitable for being loaded by a processor, to perform the operations in any image generation method provided in the embodiments of this application.

According to a fifth aspect, an embodiment of this application further provides a computer program product, including computer instructions, the computer instructions being loaded and executed by a processor, to implement the operations in any image generation method provided in the embodiments of this application.

Details of one or more embodiments of this application are provided in the following accompanying drawings and descriptions. Other features, objectives, and advantages of this application become clear with reference to the specification, the accompanying drawings, and the claims.

### BRIEF DESCRIPTION OF THE DRAWINGS

To illustrate embodiments of this application or the technical solutions in the conventional technology, the accompanying drawings required for use in the embodiments or the descriptions of the conventional technology are briefly described below. The accompany drawings described below are the embodiments of this application. For an ordinary person skilled in the art, other accompanying drawings may be further obtained based on the disclosed accompanying drawings without any creative work.

FIG. 1 is a schematic diagram of a scenario of an image generation method according to an embodiment of this application.

FIG. 2 is a schematic flowchart of an image generation method according to an embodiment of this application.

FIG. 3 is a schematic flowchart of a palm print image generation method in a training phase according to an embodiment of this application.

FIG. 4 is a schematic flowchart of a palm print image generation method in an application phase according to an embodiment of this application.

FIG. 5 is a schematic structural diagram of an image generation apparatus according to an embodiment of this application.

FIG. 6 is a schematic structural diagram of an electronic device according to an embodiment of this application.

### DESCRIPTION OF EMBODIMENTS

The following describes the technical solutions in the embodiments of this application with reference to the accompanying drawings in the embodiments of this application. The described embodiments are a part of the embodiments of this application rather than all of the embodiments. Based on the embodiments of this application, all other embodiments obtained by an ordinary person skilled in the art without making any creative work fall within a scope of protection of this application.

The embodiments of this application provide an image generation method and apparatus, an electronic device, and a storage medium.

The image generation apparatus may be specifically integrated into an electronic device, and the electronic device may be a device such as a terminal or a server. The terminal may be a device such as a mobile phone, a tablet computer, a smart Bluetooth device, a laptop computer, or a personal computer (PC); and the server may be a single server, or may be a server cluster including a plurality of servers.

In some embodiments, the image generation apparatus may alternatively be integrated into a plurality of electronic devices. For example, the image generation apparatus may be integrated into the plurality of servers, and the plurality of servers implement the image generation method in this application.

In some embodiments, the server may alternatively be implemented by the terminal, that is, the terminal may have all or a part of functions of the server.

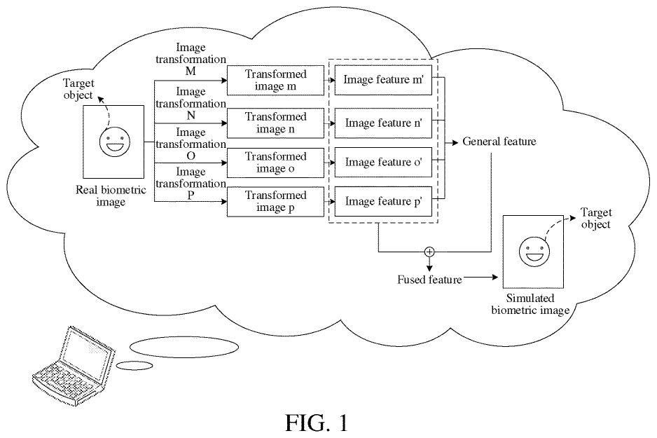

For example, refer to FIG. 1. The electronic device may be a personal computer, and the personal computer can obtain a real biometric image of a target object; perform, on the real biometric image, a plurality of image transformations with an identity feature of the target object retained, such as an image transformation M, an image transformation N, an image transformation O, and an image transformation P, to obtain transformed images respectively corresponding to the plurality of image transformations; perform feature extraction on a transformed image corresponding to each image transformation, to obtain an image feature of the transformed image, that is, an image feature m′ of a transformed image m, an image feature n′ of a transformed image n, an image feature o′ of a transformed image o, and an image feature p′ of a transformed image p; generating, based on the image features of the transformed images, a general feature of the target object; fuse the general feature with the image transformation feature, to obtain a fused feature; and generate, based on the fused feature, a simulated biometric image of the target object.

Detailed descriptions are separately provided below. Sequence numbers of the following embodiments are not intended to limit a preferred order of the embodiments.

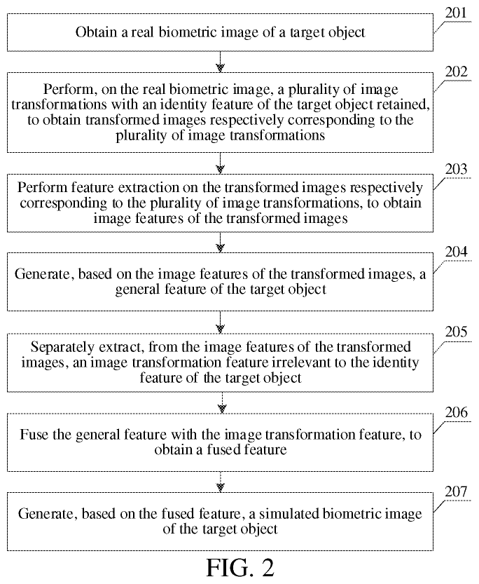

In this embodiment, a computer vision-based image generation method relating to artificial intelligence is provided. As shown in FIG. 2, the following shows a specific process of the image generation method.

201: Obtain a real biometric image of a target object.

The target object refers to an object, and the object may be a complete individual, or may be a part constituting the complete individual. For example, the object may be a person, a face, a palm, a finger, an iris, a lip, an ear, or the like. In this embodiment of this application, identification (ID) may be assigned to the target object for representing or authenticating the object. For example, a serial number is assigned to each finger, and the serial number refers to a finger of a person.

A biometric image is an image for identifying or recognizing an identity of the object by using a biological feature, such as a full-body photograph, a face image, a palm print image, a fingerprint image, an iris image, a finger vein image, an ear image, a skin texture image, or a lip print image of a person.

In this embodiment of this application, there are a plurality of manners of obtaining the real biometric image of the target object. For example, the real biometric image is obtained through acquisition performed on the target object by using an acquisition device, where the acquisition device includes, but is not limited to, an optical sensor, a high-resolution camera, a scanner, a camera, and the like; and for example, the real biometric image is obtained from an image data server.

202: Perform, on the real biometric image, a plurality of image transformations with an identity feature of the target object retained, to obtain transformed images respectively corresponding to the plurality of image transformations.

An image transformation is transformation performed on an image with the identity feature of the target object retained. An obtained transformed image is different from the real biometric image and retains the identity feature of the target object.

The image transformation may be obtained through attribute editing performed on the real biometric image. An attribute may be, for example, a photographing angle, an aperture size, blocking, a focal length, a halo and a bokeh ball, motion shaking, or a color correction. The image transformation is not an arbitrary change to a real biometric image. Different from a beautification transformation, the image transformation does not change the identity feature of the target object in the image, but only adds a non-identity feature in the image. In other words, the image transformation does not affect a visual effect of identity feature recognition. Therefore, the image transformation does not affect accuracy of identity recognition.

In some embodiments, the image transformation may include an angle transformation, and the angle transformation may be configured for imitating an angle transformation of a lens photographing the target object; in some embodiments, the image transformation may include an illumination transformation, and the illumination transformation is configured for imitating a change in illumination received by the lens photographing the target object; in some embodiments, the image transformation may include partial blocking, and the partial blocking is configured for imitating an effect that the lens photographing the target object is blocked by an obstruction, for example, the lens is blocked by a hand; and in some embodiments, the image transformation may include blur processing, and the blur processing is configured for imitating a situation that imaging of the lens photographing the target object is blurred, and the like.

203: Perform feature extraction on the transformed images respectively corresponding to the plurality of image transformations, to obtain image features of the transformed images.

There are a plurality of manners of image feature extraction. For example, the image feature extraction may be implemented through a conventional operator, a principal component analysis (PCA), an autoencoder, a local binary pattern (LBP), a histogram of oriented gradients (HOG), a convolutional neural network (CNN), Fourier transform, a filter, and other methods.

In some embodiments, operation 203 may be performed by using an encoder. To resolve a gradient propagation problem, mitigate overfitting, and improve an encoder representation capability of the encoder in a training phase, the encoder may be designed to include k residual blocks connected in series. A residual block is configured to resolve problems of gradient disappearance and gradient explosion during deep network training, and includes a convolutional layer, a normalization layer, and an activation function. k is a positive integer.

The convolutional layer is configured to extract an image feature; the normalization layer is configured to reduce an internal covariate shift in a deep neural network and accelerate a training process; and the activation function is configured to introduce a nonlinear property into a neural network.

There are a plurality of convolutional layers, for example, a standard convolutional layer, a depthwise separable convolutional layer, a dilated convolutional layer, a transpose convolutional layer, and an atrous convolutional layer.

There are a plurality of normalization layers, for example, batch normalization (BN), layer normalization, and group normalization.

There are a plurality of activation functions, for example, a rectified linear unit (ReLU), a sigmoid, a hyperbolic tangent (Tanh), a Leaky ReLU, a parametric ReLU (PReLU), and an exponential linear unit (ELU).

204: Generate, based on the image features of the transformed images, a general feature of the target object.

The general feature refers to a feature reflected by image features of all of the transformed images as a whole. The general feature may outline common visual features presented by the target object under different image transformations, that is, visual features that are irrelevant to the image transformation and only relevant to the target object. Therefore, the general feature is highly correlated to visual representation of an identity of the target object.

There are a plurality of manners of obtaining the general feature of the image features of the transformed images, for example, through feature addition, feature averaging, feature weighted fusion, and feature mapping.

In some embodiments, the general feature may be calculated through feature averaging, and the general feature is an average feature. Operation 204 may include: calculating an average value of the image features of the transformed images, to obtain an average feature of the image features. The image feature may be in a form of a matrix. Calculating an average value of image features in the form of a matrix may be separately calculating an average value of elements in the image features in the form of a matrix. In this embodiment, the general feature can be quickly determined by calculating an average value, thereby improving overall efficiency of generating a simulated biometric image.

205: Separately extract, from the image features of the transformed images, an image transformation feature irrelevant to the identity feature of the target object.

The image transformation feature is a visual feature irrelevant to the target object and only relevant to the image transformation. The image feature of the transformed image includes both a visual feature of the image transformation and a visual feature of the target object. Through operation 204 and operation 205, a feature relevant to the target object and the image transformation feature irrelevant to the identity feature of the target object are separately extracted. Being irrelevant to the identity feature of the target object may be that a correlation with the identity feature of the target object is less than a specific threshold, and the threshold may be set according to a practical requirement.

There are a plurality of manners of image transformation feature extraction. For example, image transformation feature extraction may be implemented by using a deep learning image transformation segmentation model, image transformation feature analysis, image transformation synthesis analysis, a multilayer perceptron (MLP), and the like.

For example, the image transformation feature extraction may be implemented by using a multilayer perceptron.

206: Fuse the general feature with the image transformation feature, to obtain a fused feature.

The fused feature may reflect the general feature and the image features of all of the transformed images. In some embodiments, there are a plurality of methods of fusing the general feature and the image features of all of the transformed images into the fused feature. For example, feature fusion is implemented through feature concatenation, feature weighted fusion, feature cross, feature stacking, feature dimensionality reduction, and the like.

In some embodiments, the general feature may be separately fused with each image transformation feature, to obtain a fused feature corresponding to each image transformation feature. In some embodiments, the general feature may be fused with all of the image transformation features, to obtain the fused feature. In some embodiments, image transformation features respectively corresponding to the plurality of image transformation may be fused with the general feature according to weights of the plurality of image transformations. The image transformation features may be first weighted according to the weights and then fused with the general feature first, or both the image transformation features and the general feature may be fused by weighted and fused according to respective weights of the image transformation features and the general feature.

In some embodiments, to implement image editing, a corresponding noise distribution may be designed for each image transformation, so that a feature distribution of the image transformation feature is consistent with the noise distribution. A preset noise distribution may include a Gaussian distribution, a uniform distribution, a salt-and-pepper distribution, a Poisson distribution, and the like.

In some embodiments, all of the image transformations may correspond to the same noise distribution, and a parameter of the noise distribution of each image transformation differs from each other.

For example, in some embodiments, operation 205 may include the following operation: separately extracting, from the image features of the transformed images, the image transformation feature irrelevant to the identity feature of the target object by using the multilayer perceptron, the feature distribution of the image transformation feature being consistent with the preset noise distribution.

In some embodiments, the multilayer perceptron needs to be trained in advance, so that the feature distribution of the image transformation feature extracted by the multilayer perceptron is consistent with the preset noise distribution. Therefore, the method may further include the following operations of multilayer perceptron training: obtaining sample image transformation features respectively corresponding to the plurality of image transformations, the sample image transformation features respectively corresponding to the plurality of image transformations being obtained by extracting, after performing the plurality of image transformations on a sample image to obtain an image subjected to sample transformation, a feature from the sample image subjected to sample transformation; determining a preset noise distribution corresponding to each image transformation performed on the sample image; calculating, for each image transformation, a distribution difference loss between the corresponding preset noise distribution and a feature distribution of the corresponding sample image transformation feature; and adjusting, based on the distribution difference loss, a parameter of the multilayer perceptron, to cause the multilayer perceptron to converge.

The distribution difference loss includes a mean difference, a variance difference, a Chi-square difference, Kullback-Leibler divergence (KL divergence), Jensen-Shannon divergence (JS divergence), and the like.

In some embodiments, the distribution difference loss includes relative entropy, that is, KL divergence. The operation of “calculating, for each image transformation, a distribution difference loss between the corresponding preset noise distribution and a feature distribution of the corresponding sample image transformation feature” may include the following operations: determining each image transformation as a target image transformation, and dividing a preset noise distribution corresponding to a target image transformation by a feature distribution of a sample image transformation feature corresponding to the target image transformation, to obtain a quotient corresponding to the target image transformation; multiplying the feature distribution of the sample image transformation feature corresponding to the target image transformation by a logarithm of the quotient corresponding to the target image transformation, to obtain a difference corresponding to the target image transformation; and taking a negative sum of differences respectively corresponding to the plurality of image transformations, to obtain the relative entropy.

Therefore, the following shows a formula of the relative entropy.

$${Loss}_{KL} = - {\sum }_{i = 1}^{N} D ( {featureattributes}_{i} ) * log \frac{{gaussiannoise}_{i}}{D ( {featureattributes}_{i} )}$$

There are N types of image transformations in total. For an image transformation i, a preset noise distribution corresponding to the image transformation i may be designed as gaussiannoise; based on Gaussian distribution, and distribution of an image transformation feature featureattributesi is f(featureattributesi).

In some embodiments, to add randomness to ensure richness and naturalness of a generated image and ensure that the feature distribution of the image transformation feature is consistent with a random noise distribution, random sampling may be performed on Gaussian noise in an inference phase. Therefore, the operation of separately extracting, from the image features of the transformed images, the image transformation feature irrelevant to the identity feature of the target object by using the multilayer perceptron, the feature distribution of the image transformation feature being consistent with the preset noise distribution may include the following operations: performing random sampling processing on the preset noise distribution, to obtain the random noise distribution; and separately extracting, from the image feature of the transformed images, the image transformation feature irrelevant to the identity feature of the target object by using the multilayer perceptron, the feature distribution of the image transformation feature being consistent with the random noise distribution.

207: Generate, based on the fused feature, a simulated biometric image of the target object.

In some embodiments, in operation 203, the feature extraction is implemented by using the encoder. Therefore, correspondingly, a decoder corresponding to the encoder is designed to implement operation 207.

Therefore, in some embodiments, operation 207 may include the following operation:
using the decoder in operation 207, the decoder including k deconvolutions connected in series, the deconvolution being configured to perform upsampling.

The deconvolution is configured to expand a spatial dimension of a feature map, thereby implementing the upsampling, so that the fused feature is restored to a resolution of an original input image, and a detail of the image is restored.

In some embodiments, content presented in a finally generated simulated biometric image may be not the target object because of problems such as inadequate training or overtraining of a model in the training phase. Therefore, to distinguish whether an object presented in the simulated biometric image is the same as the target object in the real biometric image in operation 201, the following operations may be further included after operation 207: calculating an image similarity between the real biometric image and the simulated biometric image; and performing, according to the image similarity, identity verification on the target object.

The performing, according to the image similarity, identity verification on the target object may include: when the image similarity belongs to a preset range, determining that an object to which the simulated biometric image belongs is the target object; or when the image similarity does not belong to the preset range, determining that the object to which the simulated biometric image belongs is not the target object.

In some embodiments, if the object to which the simulated biometric image belongs is not the target object, the simulated biometric image can be deleted.

In this embodiment of this application, the real biometric image of the target object may be obtained; the plurality of image transformations with the identity feature of the target object retained may be performed on the real biometric image, to obtain the transformed images respectively corresponding to the plurality of image transformations; the feature extraction may be performed on the transformed images respectively corresponding to the plurality of image transformations, to obtain the image features of the transformed images; the general feature of the target object may be generated based on the image features of the transformed images; the general feature may be fused with the image transformation feature, to obtain the fused feature; and the simulated biometric image of the target object may be generated based on the fused feature. In the embodiments of this application, decoupling and learning may be performed on a plurality of image transformations irrelevant to the target object, so that the real biometric image can be edited based on the plurality of image transformations, thereby resolving a limitation that an existing image generation method relies on a large amount of training data and improving an image generation effect with an excessively small amount of training data. Therefore, this solution can improve efficiency of simulated biometric image generation.

According to the method described in the foregoing embodiment, the following further describes the method in detail.

In this embodiment, the method in the embodiments of this application is described in detail by using palm print recognition in a case of one or two samples as an example.

As shown in FIG. 3, the following shows a specific procedure of an image generation method in a training phase.

In this embodiment, a palm print image x of a target palm may be acquired by a sensor. The target palm may have identity ID.

Refer to FIG. 3. In this embodiment, an image generation model may be trained to perform, on the palm print image x, a plurality of image transformations with an identity feature of the target palm retained, to obtain transformed images respectively corresponding to the plurality of image transformations, and feature extraction is respectively performed on the transformed images respectively corresponding to the plurality of image transformations by using an encoder, to obtain an image features of the transformed images. Further, an average feature and an image transformation feature are obtained based on the image feature of the transformed image, to fuse the average feature and the image transformation feature and upsample a fused feature by using a decoder, to generate a simulated palm print image.

The image transformation may include a random affine transformation (imitating an angle transformation), a random brightness transformation (imitating an illumination change), random black block blocking (imitating a case of a hand being blocked), random Gaussian blur (imitating a case of camera imaging being blurred), and the like.

For example, a transformed image x₁ may be obtained by performing angle transformation (a function of the angle transformation is marked as effect_1) on the palm print image x, and x₁×1=effect_1(x). A transformed image x₂ may be obtained by performing random brightness transformation (a function of the random brightness transformation is marked as effect_2) on the palm print image x, and x₂=effect_2(x). A transformed image x₃ may be obtained by performing hand blocking intimating transformation (a function of the hand blocking intimating transformation is marked as effect_3) on the palm print image x, and x₃=effect_3(x). A transformed image x₄ may be obtained by performing image blurring transformation (a function of the image blurring transformation is marked as effect_4) on the palm print image x, and ×4=effect_4(x).

The palm print image x on which an image transformation i is performed is a transformed image xᵢ. The encoder may extract an image feature featureᵢ of the transformed image xᵢ, and featureᵢ=Encoder (xᵢ), where i∈N, and Nis a total quantity of the image transformations.

In some embodiments, the encoder may include three residual blocks connected in series, and each residual block includes a convolutional layer, a batchnormalization layer, and a linear rectification function (relu) layer.

In some embodiments, the encoder in the training phase may use an arcface (a function name of a face recognition function) function as a loss function, and a fully connected layer of an identity recognition loss LossID part may be removed in an application phase.

Refer to FIG. 3. A three-layer MLP may be configured to generate an image transformation feature featureattributesᵢ:

$${featureattributes}_{i} = MLP ( {feature}_{i} )$$

The image transformation feature is irrelevant to the target palm, and is only relevant to the image transformation.

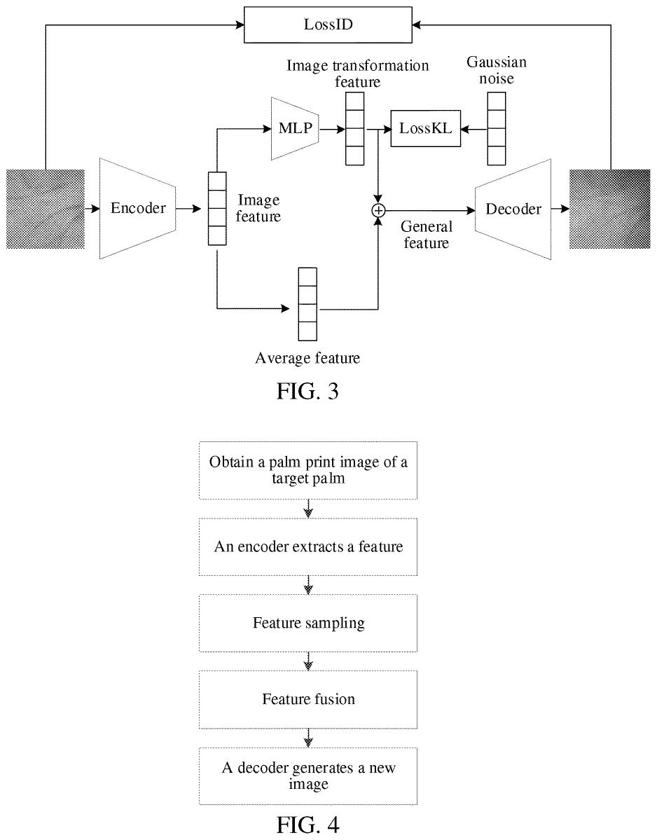

Refer to FIG. 4. The image feature featureᵢ may be averaged to obtain an average feature feature_id_i:

$$feature\_id \_i = mean ( {feature}_{i} , i ∈ ( 1 , N ) )$$

The average feature is irrelevant to the image transformation, and is only relevant to the target palm.

In some embodiments, refer to FIG. 3. To implement image editing, in this embodiment, a feature of the transformed image may be constrained, to cause the feature to be consistent with a Gaussian noise distribution, so that in the application phase, the image editing may be implemented through random sampling on the Gaussian noise distribution.

In some embodiments, a specific constraint manner may be to use KL divergence to constrain a difference Loss_{KL} between the transformed image feature distribution and the Gaussian noise distribution:

$${Loss}_{KL} = - {\sum }_{i = 1}^{N} {featureattributes}_{i} * log \frac{{gaussiannoise}_{i}}{{featureattributes}_{i}}$$

Refer to FIG. 3. The image transformation feature and the average feature are concatenated to obtain a concatenated feature concat (feature_id_i, featureattributesᵢ).

Refer to FIG. 4. The fused feature may be upsampled to a new image Generated_palmᵢ by using the decoder:

$${Generated\_palm}_{i} = Decoder ( concat ( feature\_id \_i , {featureattributes}_{i} ) )$$

In some embodiments, to ensure that a generated image and a target id image have the same identity information, a pre-trained palm print recognition model Model_Rec is used herein to extract a feature of the target id image and a feature of the generated image, a cosine similarity between the feature of the target id image and the feature of the generated image is calculated, and the identity recognition loss LossID is calculated:

$$LossID = 1 - cosine ( Model\_Rec ( {Generated\_palm}_{i} ) , Model\_Rec ( {x}_{i} ) )$$

A parameter of the model based on the identity recognition loss LossID is updated until a training stopping condition is met. The training stopping condition may be that iterations reach a preset number of times, a testing effect of a trained model reaches an expectation, or a model difference between two adjacent iterations is less than a preset threshold.

At this point, the training phase ends.

Refer to FIG. 4. In the application phase, a single palm print image of the target palm may be acquired; an image feature of a transformed image of the palm print image may be extracted by using the encoder; an average feature and an image transformation feature may be calculated; the average feature and the image transformation feature may be concatenated and fused; and a new image by using the decoder may be generated.

In the present disclosure, images of the same hand in a plurality of different scenarios are generated through an ingenious image editing manner, that is, through image transformations such as an angle transformation and illumination transformation, thereby generating more data about the hand, to generate a simulated palm print image of the hand based on the data. Therefore, generation of a plurality of new palm print images based on a small sample is achieved, a problem that an existing generation method relies on a large amount of existing data is resolved, and image generation efficiency is improved.

To better implement the foregoing method, an embodiment of this application further provides an image generation apparatus. The image generation apparatus may be specifically integrated into an electronic device, and the electronic device may be a device such as a terminal or a server. The terminal may be a device such as a mobile phone, a tablet computer, a smart Bluetooth device, a laptop computer, or a personal computer; and the server may be a single server, or may be a server cluster including a plurality of servers.

For example, in this embodiment, the method in the embodiments of this application is described in detail by using an image generation apparatus specifically integrated into the server as an example.

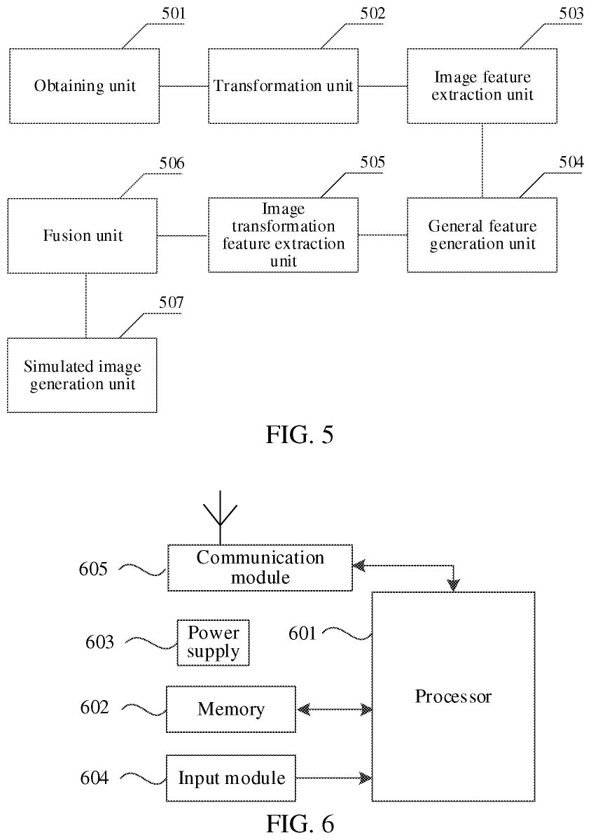

For example, as shown in FIG. 5, the image generation apparatus may include an obtaining unit 501, a transformation unit 502, an image feature extraction unit 503, a general feature generation unit 504, a fusion unit 506, and a simulated image generation unit 507, which are described as follows.

### (1) Obtaining Unit 501.

The obtaining unit 501 is configured to obtain a real biometric image of a target object.

In some embodiments, the real biometric image of the target object includes a palm print image of a palm, a fingerprint image of a finger, an iris image of a pupil, and a face image of a person.

### (2) Transformation Unit 502.

The transformation unit 502 is configured to perform, on the real biometric image, a plurality of image transformations with an identity feature of the target object retained, to obtain transformed images respectively corresponding to the plurality of image transformations.

In some embodiments, an image transformation includes an angle transformation, an illumination transformation, partial blocking, and blur processing.

In some embodiments, the transformation unit 502 is configured to:
perform, by using an encoder, feature extraction on the transformed images respectively corresponding to the plurality of image transformations, to obtain the image features of the transformed images, the encoder including k residual blocks connected in series, the residual block including a convolutional layer, a normalization layer, and an activation function, k being a positive integer.

### (3) Image Feature Extraction Unit 503.

The image feature extraction unit 503 is configured to perform feature extraction on the transformed images respectively corresponding to the plurality of image transformations, to obtain image features of the transformed images;

### (4) General Feature Generation Unit 504.

The general feature generation unit 504 is configured to generate, based on the image features of the transformed images, a general feature of the target object.

In some embodiments, the general feature includes an average feature, and the general feature generation unit 504 is configured to:
perform average processing on all of image features, to obtain an average feature of the image features.

### (5) Image Transformation Feature Extraction Unit 505.

The image transformation feature extraction unit 505 is configured to separately extract, from the image features of the transformed images, an image transformation feature irrelevant to the identity feature of the target object.

In some embodiments, the image transformation feature extraction unit 505 is configured to separately extract, from the image features of the transformed images, the image transformation feature irrelevant to the identity feature of the target object by using a multilayer perceptron, a feature distribution of the image transformation feature being consistent with a preset noise distribution.

In some embodiments, the image transformation feature extraction unit 505 is configured to perform random sampling processing on the preset noise distribution, to obtain a random noise distribution; and separately extract, from the image feature of the transformed images, the image transformation feature irrelevant to the identity feature of the target object by using the multilayer perceptron, and the feature distribution of the image transformation feature is consistent with the random noise distribution.

### (6) Fusion Unit 506.

The fusion unit 506 is configured to fuse the general feature with the image transformation feature, to obtain a fused feature.

In some embodiments, the image transformation feature of the transformed image includes an adjustment feature, and a vision subunit is configured to:

separately extract, from the image features of the transformed images, the image transformation feature irrelevant to the identity feature of the target object by using the multilayer perceptron, the feature distribution of the image transformation feature being consistent with the preset noise distribution.

In some embodiments, before the vision subunit, a training subunit is further included, and the training subunit includes:
a sample submodule, configured to obtain a training sample, the training sample including an image transformation feature of a transformed image corresponding to each image transformation;
a preset submodule, configured to determine a preset noise distribution corresponding to each image transformation;
a loss submodule, configured to calculate, for each image transformation, a distribution difference loss between the corresponding preset noise distribution and a feature distribution of the corresponding sample image transformation feature; and
a convergence submodule, configured to adjust, based on the distribution difference loss, a parameter of the multilayer perceptron, to cause the multilayer perceptron to converge.

In some embodiments, the distribution difference loss includes relative entropy, and the loss submodule is configured to:
for each image transformation, divide the corresponding preset noise distribution by the feature distribution of the corresponding image transformation feature, to obtain an image transformation quotient;
for the image transformation, multiply the feature distribution of the corresponding image transformation feature by a logarithm of the quotient, to obtain an image transformation difference; and
take a negative sum of differences of all of the image transformations, to obtain the relative entropy.

In some embodiments, the separately extracting, from the image features of the transformed images, the image transformation feature irrelevant to the identity feature of the target object by using the multilayer perceptron, the feature distribution of the image transformation feature being consistent with the preset noise distribution includes:
performing random sampling processing on the preset noise distribution, to obtain a random noise distribution; and
separately extracting, from the image features of the transformed images, the image transformation feature irrelevant to the identity feature of the target object by using the multilayer perceptron, the feature distribution of the image transformation feature being consistent with the random noise distribution.

### (7) A Simulated Image Generation Unit 507.

The simulated image generation unit 507 is configured to generate, based on the fused feature, a simulated biometric image of the target object.

In some embodiments, the simulated image generation unit 507 is configured to:
generate, by using a decoder, based on the fused feature, the simulated biometric image of the target object, the decoder including k deconvolutions connected in series, the deconvolution being configured to perform upsampling.

In some embodiments, the simulated image generation unit 507 is further configured to:
calculate an image similarity between the real biometric image and the simulated biometric image;
when the image similarity belongs to a preset range, determine that an object to which the simulated biometric image belongs is the target object; and
when the image similarity does not belong to the preset range, determine that the object to which the simulated biometric image belongs is not the target object.

During specific implementation, the foregoing units may be implemented as independent entities, or may be combined in different manners to form one or several entities. For the specific implementation of the foregoing units, refer to the foregoing method embodiments, and details are not described herein again.

In the image generation apparatus in this embodiment, the obtaining unit obtains the real biometric image of the target object; the transformation unit performs, on the real biometric image, the plurality of image transformations with the identity feature of the target object retained, to obtain the transformed images respectively corresponding to the plurality of image transformations; the image feature extraction unit performs the feature extraction on the transformed images respectively corresponding to the plurality of image transformations, to obtain image features of the transformed images; the general feature generation unit generates, based on the image features of the transformed images, a general feature of the target object; the fusion unit fuses the general feature with the image transformation feature, to obtain a fused feature; and the simulated image generation unit generates, based on the fused feature, the simulated biometric image of the target object.

Therefore, in this embodiment of this application, efficiency of generating a simulated biometric image based on an image can be improved.

An embodiment of this application further provides an electronic device. The electronic device may be a device such as a terminal or a server. The terminal may be a mobile phone, a tablet computer, a smart Bluetooth device, a laptop computer, a personal computer, or the like; and the server may be a single server, or may be a server cluster including a plurality of servers, or the like.

In some embodiments, the image generation apparatus may alternatively be integrated into a plurality of electronic devices. For example, the image generation apparatus may be integrated into the plurality of servers, and the plurality of servers implement the image generation method in this application.

In this embodiment, detailed descriptions are provided by using an example in which the electronic device in this embodiment is a server. For example, FIG. 6 is a schematic structural diagram of an electronic device according to an embodiment of this application. Specifically,
the electronic device may include components such as a processor 601 including one or more processing cores, a memory 602 including one or more computer-readable storage media, a power supply 603, an input module 604, and a communication module 605. A person skilled in the art may understand that a structure of the electronic device shown in FIG. 6 does not constitute a limitation to the electronic device, and the electronic device may include more components or fewer components than the components shown in the figure, a combination of some components, or different component arrangements.

The processor 601 is a control center of the electronic device, connects various parts of the electronic device through various interfaces and lines, and executes various functions of the electronic device and processes data by running or executing a software program and/or a module stored in the memory 602 and invoking data stored in the memory 602, thereby performing overall detection on the electronic device. In some embodiments, the processor 601 may include one or more processing cores. In some embodiments, the processor 601 may integrate an application processor and a modem processor, where the application processor mainly processes an operating system, a user interface, an application program, and the like, and the modem processor mainly processes wireless communication. The foregoing modem processor may not be integrated into the processor 601.

The memory 602 may be configured to store a software program and a module. The processor 601 runs the software program and the module stored in the memory 602, to execute various functional applications and data processing. The memory 602 may mainly include a program storage area and a data storage area, where the program storage area may store the operating system, an application program required by at least one function (such as a sound playback function and an image display function), and the like; and the data storage area may store data created according to use of the electronic device, and the like. In addition, the memory 602 may include a high-speed random access memory, and may further include a non-volatile memory such as at least one magnetic disk storage device and a flash memory, or another volatile solid-state storage device. Correspondingly, the memory 602 may further include a memory controller, to provide access of the processor 601 to the memory 602.

The electronic device further includes the power supply 603, configured to supply power to the components. In some embodiments, the power supply 603 may be logically connected to the processor 601 by using a power management system, thereby implementing functions such as charging, discharging, and power consumption management by using the power management system. The power supply 603 may further include one or more of a direct current power supply or an alternating current power supply, a recharging system, a power failure detection circuit, a power supply converter or a power supply inverter, a power supply status indicator, and any other component.

The electronic device may further include the input module 604, where the input module 604 may be configured to receive inputted digit or character information, and generate a keyboard, mouse, joystick, optical, or trackball signal input relevant to user setting and function control.

The electronic device may further include the communication module 605. In some embodiments, the communication module 605 may include a wireless module. The electronic device may perform short-distance wireless transmission by using the wireless module of the communication module 605, to provide wireless broadband Internet access for a user. For example, the communication module 605 may be configured to help the user receive and send an email, browse a web page, access streaming media, and the like.

Although not shown, the electronic device may further include a display unit and the like, which are not further described herein. Specifically, in this embodiment, the processor 601 in the electronic device may load an executable file corresponding to a process of one or more application programs into the memory 602, and the processor 601 runs the application programs stored in the memory 602, to implement various functions, according to the following instructions: obtaining a real biometric image of a target object; performing, on the real biometric image, a plurality of image transformations with an identity feature of the target object retained, to obtain transformed images respectively corresponding to the plurality of image transformations; performing feature extraction on the transformed images respectively corresponding to the plurality of image transformations, to obtain an image features of the transformed images; generating, based on the image features of the transformed images, a general feature of the target object; fusing the general feature with the image transformation feature, to obtain a fused feature; and generating, based on the fused feature, a simulated biometric image of the target object.

For specific implementation of the foregoing operations, refer to the foregoing embodiments, and details are not described herein again.

In the embodiment of this application, efficiency of generating a simulated biometric image can be improved.

An ordinary person skilled in the art may understand that all or some of the steps of the methods in the foregoing embodiments may be implemented by instructions, or implemented by the instructions controlling relevant hardware. The instructions may be stored in a computer-readable storage medium, and loaded and executed by a processor.

Therefore, an embodiment of this application provides a computer-readable storage medium, the computer-readable storage medium having a plurality of instructions stored therein, the instructions being capable of being loaded by a processor, to perform the operations in any image generation method provided in the embodiments of this application. For example, the instructions may perform the following operations: obtaining a real biometric image of a target object; performing, on the real biometric image, a plurality of image transformations with an identity feature of the target object retained, to obtain transformed images respectively corresponding to the plurality of image transformations; performing feature extraction on the transformed images respectively corresponding to the plurality of image transformations, to obtain image features of the transformed images; generating, based on the image features of the transformed images, a general feature of the target object; fusing the general feature with the image transformation feature, to obtain a fused feature; and generating, based on the fused feature, a simulated biometric image of the target object.

The storage medium may include: a read-only memory (ROM), a random access memory (RAM), a magnetic disk, an optical disc, or the like.

According to an aspect of this application, a computer program product or a computer program is provided. The computer program product or the computer program includes computer instructions, and the computer instructions are stored in a computer-readable storage medium. A processor of a computer device reads the computer instructions from the computer-readable storage medium, and the processor executes the computer instructions, so that the computer device performs the methods provided in various exemplary implementations of an image generation aspect or an identity recognition aspect provided in the foregoing embodiments.

Because the instructions stored in the storage medium can perform the operations in any image generation method provided in the embodiments of this application, a beneficial effect that can be implemented by the any image generation method provided in the embodiments of this application can be achieved. For details, refer to the foregoing embodiments, and details are not described herein again.

Technical features of the foregoing embodiments may be combined in different manners to form other embodiments. For brevity of the descriptions, not all possible combinations of the technical features in the foregoing embodiments are described. However, provided that combinations of the technical features do not contradict each other, the combinations of the technical features are to be considered to fall within the scope recorded in this specification.

The foregoing embodiments only describe several implementations of this application, which are described specifically and in detail, but cannot be construed as a limitation to the patent scope of the present disclosure. An ordinary person skilled in the art may further make various changes and improvements without departing from the ideas of this application, and these changes and improvements all fall within the protection scope of this application. Therefore, the protection scope of the patent of this application shall be subject to the appended claims.

What is claimed is:

1. An image generation method, performed by a computer device, the method comprising:
obtaining a real biometric image of a target object;
applying a plurality of image transformations to the real biometric image to obtain a plurality of transformed images, each transformed image retaining an identify feature of the target object;
extracting a feature from each transformed image to obtain a plurality of image features;
generating a general feature of the target object based on the plurality of image features;
extracting a plurality of image transformation features from the plurality of image features, each image transformation feature being irrelevant to the identity feature of the target object;
fusing the general feature with the plurality of image transformation features to create a fused feature; and
generating a simulated biometric image of the target object based on the fused feature.

2. The method according to claim 1, wherein extracting the plurality of image transformation features from the plurality of image features comprises:
extracting the plurality of image transformation features from the plurality of image features by using a multilayer perceptron, a feature distribution of each image transformation feature being consistent with a preset noise distribution.

3. The method according to claim 2, further comprising:
applying the plurality of image transformations on a sample image to obtain a plurality of sample transformed images;
extracting a plurality of sample image transformation features from the plurality of sample transformed images;
determining a preset noise distribution corresponding to each image transformation performed on the sample image;
calculating, for each image transformation, a distribution difference loss between the preset noise distribution and a feature distribution of a corresponding sample image transformation feature; and
adjusting, based on the distribution difference loss, at least one parameter of the multilayer perceptron such that the at least one parameter converges.

4. The method according to claim 3, further comprises:
calculating, as the distribution difference loss, a relative entropy by:
calculating a difference corresponding to each image transformation, comprising:
dividing the preset noise distribution by the feature distribution of the corresponding sample image transformation feature to obtain a quotient;
multiplying the feature distribution of the corresponding sample image transformation feature by a logarithm of the quotient to obtain the difference corresponding to the each image transformation; and
taking a negative sum of differences corresponding to the plurality of image transformations as the relative entropy.

5. The method according to claim 1, further comprises:
performing random sampling processing on a preset noise distribution to obtain a random noise distribution; and
extracting the plurality of image transformation features from the plurality of image features by using a multilayer perceptron, a feature distribution of each image transformation feature being consistent with the random noise distribution.

6. The method according to claim 1, further comprising:
calculating an image similarity between the real biometric image and the simulated biometric image; and
performing, according to the image similarity, identity verification on the target object.

7. The method according to claim 6, wherein performing, according to the image similarity, identity verification on the target object comprises:
when the image similarity falls within a preset range, determining that the simulated biometric image corresponds to the target object; or
when the image similarity does not fall within the preset range, determining that the simulated biometric image does not correspond to the target object.

8. The method according to claim 1, wherein generating the general feature of the target object based on the plurality of image features comprises:
calculating an average value of the plurality of image features to obtain the general feature of the target object.

9. The method according to claim 1, wherein the plurality of image transformations comprise at least one of: angle transformation, illumination transformation, partial blocking, or blur processing.

10. The method according to claim 1, wherein extracting the feature from the each transformed images to obtain the plurality of image features comprises:
extracting, by an encoder, the feature from the each transformed images to obtain the plurality of image features, the encoder comprising k residual blocks connected in series, each residual block comprising a convolutional layer, a normalization layer, and an activation function, k being a positive integer.

11. The method according to claim 10, wherein generating the simulated biometric image of the target object based on the fused feature comprises:
generating, by a decoder, the simulated biometric image of the target object based on the fused feature, the decoder comprising k deconvolutions connected in series, the k deconvolutions being configured to perform upsampling.

12. The method according to claim 1, wherein the real biometric image of the target object comprises at least one of: a palm print image of a target palm, a fingerprint image of a target finger, an iris image of a target pupil, or a face image of a target person.

13. An image generation apparatus, comprising a memory for storing instructions and at least one processor configured to execute the instructions to:
obtain a real biometric image of a target object;
apply a plurality of image transformations to the real biometric image to obtain a plurality of transformed images, each transformed image retaining an identify feature of the target object;
extract a feature from each transformed images to obtain a plurality of image features;
generate a general feature of the target object based on the plurality of image features;
extract a plurality of image transformation features from the plurality of image features, each image transformation features being irrelevant to the identity feature of the target object;
fuse the general feature with the plurality of image transformation features to create a fused feature; and
generate a simulated biometric image of the target object based on the fused feature.

14. The image generation apparatus of claim 13, wherein the at least one processor, when executing the instructions to extract the plurality of image transformation features, is configured to:
extract the plurality of image transformation features from the plurality of image features by using a multilayer perceptron, a feature distribution of each image transformation feature being consistent with a preset noise distribution.

15. The image generation apparatus of claim 14, wherein the at least one processor, when executing the instructions to extract the plurality of image transformation features, is further configured to:
apply the plurality of image transformations on a sample image to obtain a plurality of sample transformed images;
extract a plurality of sample image transformation features from the plurality of sample transformed images;
determine a preset noise distribution corresponding to each image transformation performed on the sample image;
calculate, for each image transformation, a distribution difference loss between the preset noise distribution and a feature distribution of a corresponding sample image transformation feature; and
adjust, based on the distribution difference loss, at least one parameter of the multilayer perceptron such that the at least one parameter converges.

16. The image generation apparatus of claim 13, wherein the at least one processor, when executing the instructions to generate the simulated biometric image of the target object, is configured to:
calculate an image similarity between the real biometric image and the simulated biometric image; and
perform, according to the image similarity, identity verification on the target object.

17. The image generation apparatus of claim 16, wherein the at least one processor, when executing the instructions to generate the simulated biometric image of the target object, is further configured to:
when the image similarity falls within a preset range, determine that the simulated biometric image corresponds to the target object; or
when the image similarity does not fall within the preset range, determine that the simulated biometric image does not correspond to the target object.

18. The image generation apparatus of claim 13, wherein the at least one processor, when executing the instructions to generate the general feature of the target object is further configured to:
calculate an average value of the plurality of image features to obtain the general feature of the target object.

19. The image generation apparatus of claim 13, wherein the at least one processor, when executing the instructions to apply the plurality of image transformations to the real biometric image to obtain the plurality of transformed images, is configured to:
apply at least one of following image transformations to the real biometric image: angle transformation, illumination transformation, partial blocking, or blur processing.

20. A non-transitory storage medium for storing computer readable instructions, the computer readable instructions, when executed by a processor in a device, causing the device to:
obtain a real biometric image of a target object;
apply a plurality of image transformations to the real biometric image to obtain a plurality of transformed images, each transformed image retaining an identify feature of the target object;
extract a feature from each transformed images to obtain a plurality of image features;
generate a general feature of the target object based on the plurality of image features;
extract a plurality of image transformation features from the plurality of image features, each image transformation features being irrelevant to the identity feature of the target object;
fuse the general feature with the plurality of image transformation features to create a fused feature; and
generate a simulated biometric image of the target object based on the fused feature.
